(19) United States
(12) Patent Application Publication
(10) Pub. No.: US 2019/0335737 A1
(43) Pub. Date: Nov. 7, 2019

(54) INTEGRATED MOSQUITO TRAP AND PLANTER DEVICE

(71) Applicant: AP&G Co., Inc., Bayonne, NJ (US)

(72) Inventor: Edward William Dolshun, Warwick, NY (US)

(21) Appl. No.: 15/972,666

(22) Filed: May 7, 2018

(51) Int. Cl. A01M 1/10; A01G 9/02; A01M 1/02

(52) U.S. Cl. CPC A01M 1/106; A01M 1/02; A01G 9/02

(57) ABSTRACT

A mosquito trapping system having a natural plant disposed proximately to a mosquito capture chamber. The capture chamber is suspended above a well configured to retain standing water. Standing water provided in the well and the plant foliage are each independent attractants to mosquitoes. A soil retaining structure is configured to allow drainage water from the soil system to flow into the well containing standing water, thereby depositing biological matter into the water. Decaying biological matter provides additional bait to attract mosquitoes.

### FIELD OF THE INVENTION

The invention relates to the field of insect traps, more specifically to a mosquito trap that also is a planter for outdoor vegetation.

### BACKGROUND OF THE INVENTION

Mosquitos are nuisance insects that are increasingly viewed as potential health threats. For example, the Aedes aegypti is a prominent mosquito that can spread dengue fever, chikungunya, zika fever, and other serious diseases.

Various devices have been developed which seek to reduce mosquito populations by attracting and killing mosquitos or their larvae. One such device is known as an autocidal gravid ovitrap, a dual-chambered unit designed to attract female mosquitoes to standing water, which is a desirable breeding ground. In such devices, a lower basin or similar receptacle is filled with water, and an upper chamber configured to allow the ingress of mosquitoes is suspended above the water-filled lower chamber. Typically, the inner walls of the capture chamber are provided with a layer of adhesive material. In use, mosquitoes are attracted to the standing water in the lower basin. To get close to the water, a mosquito must enter the upper chamber. Upon doing so, the mosquito will contact and stick to the adhesive layer, and thereby become trapped in the capture chamber.

A female mosquito who does not contact the adhesive layer of the capture chamber may avoid capture and survive to lay eggs. In this respect, the device is configured to allow eggs to pass from the capture chamber into the infusion chamber through a selectively penetrable screen formed of a series of pores that are sized to allow passage of mosquito eggs, but not mosquitoes. As a result, mosquitoes that may hatch in the infusion chamber remain trapped therein.

In conventional use, decaying biological matter such as hay or the like is placed into the lower basin to serve as an additional attractant of mosquitoes.

Conventional ovitraps have several impediments that may hinder widespread adoption. For instance, in order to be most effective, ovitraps are required to be rather large and, as such, they can be obtrusive and unsightly. In addition, fresh decaying matter must be continually added to the infusion chamber during long term use. Still furthermore, known ovitraps have limited ability to attract mosquitoes because they do not offer a natural environment that is attractive to mosquitoes.

### SUMMARY OF THE INVENTION

Embodiments of the invention are directed to an integrated planter and ovitrap system. The planter-trap is formed of a natural plant that is integrated with a mosquito trap. The plant is naturally attractive, making the planter-trap suitable for outdoor decoration or landscaping. At the same time, the integrated mosquito trap functions to trap mosquitoes.

The planter-trap device is formed of a capture chamber, an infusion chamber, and a soil system that supports plants and foliage. The plant and its soil system are positioned above the infusion chamber and a series of drainage apertures disposed below the soil system allows biological matter to flow with drainage water from the soil system into the infusion chamber below. In this manner, biological plant matter is automatically deposited into the infusion chamber concomitant with rainfall or watering of the plant. The plant, thus, continually supplies the trap with biological material, thereby enhancing the trap's attractiveness to mosquitoes.

In addition, the live foliage or other vegetation grown in the planter-trap provides a natural environment for mosquitoes, thereby further increasing the planter-trap's attractiveness to mosquitoes.

The live plant segment of the planter-trap, thus, serves several purposes in embodiments of the invention. For example, the plant provides aesthetic cover to the underlying trap, thereby enhancing the device's adoptability. In addition, the plant and its foliage serve as an additional attractant to lure adult mosquitoes seeking rest. Still further, the plant is a continued source of biological material.

Thus, planter-traps of the invention which support natural plants are aesthetically pleasing, and they may be used to adorn outdoor spaces while simultaneously reducing mosquito populations. The integration of the plant and mosquito trap synergistically enhance the trap's effectiveness and provides self-sustainability.

The invention also provides a method of trapping mosquitos by providing a basin configured to hold a predetermined volume of liquid as an attractant, with an added attractant of natural vegetation. Furthermore, the invention provides a method of automatically replenishing attractant in a mosquito trap during rainfall or other watering.

Other principal features and advantages of the invention will become apparent to those skilled in the art upon review of the following drawings, the detailed description, and the appended claims.

### BRIEF DESCRIPTION OF THE DRAWINGS

Illustrative embodiments of the invention will hereafter be described with reference to the accompanying drawings, wherein like numerals denote like elements.

FIG. 1 is an exploded view of a planter-trap according to an exemplary embodiment of the invention.

FIG. 2 is an exploded view of a capture chamber according to an exemplary embodiment of the invention.

FIG. 3 is a top plan view of an empty planter-trap according to an exemplary embodiment of the invention.

FIG. 4 is a cross-sectional view of the planter-trap of FIG. 3 taken through the plane A-A according to an exemplary embodiment of the invention.

FIG. 5 is a cross-sectional view of a planter-trap shown in use according to an exemplary embodiment of the invention.

FIG. 6 is a top perspective view of a planter-trap shown empty according to an exemplary embodiment of the invention.

FIG. 7 top perspective view of a planter-trap shown filled with soil according to an exemplary embodiment of the invention.

FIG. 8 is a top perspective view of a planter-trap shown with live foliage according to an exemplary embodiment of the invention.

### DETAILED DESCRIPTION OF THE INVENTION

Embodiments of the present invention will now be described with reference to the above-identified Drawings. However, the Drawings and the description herein are not intended to limit the scope of the claims. It will be understood that various modifications of the present description are possible without departing from the spirit of the invention. Also, features described herein may be omitted, additional features may be included, and/or features described herein may be combined in a manner different from the specific combinations recited herein, all without departing from the spirit of the invention.

Female mosquitoes in search of appropriate breeding grounds are attracted to standing water, which is necessary for the survival of mosquito larvae. Mosquitoes are also attracted to decaying biological matter such as hay or grass. Furthermore, mosquitoes tend to gravitate to leafy foliage as a place to rest.

The planter-trap set forth herein provides all of the above favorable conditions for attracting mosquitoes, which in combination, may increase the device's efficacy in attracting mosquitoes.

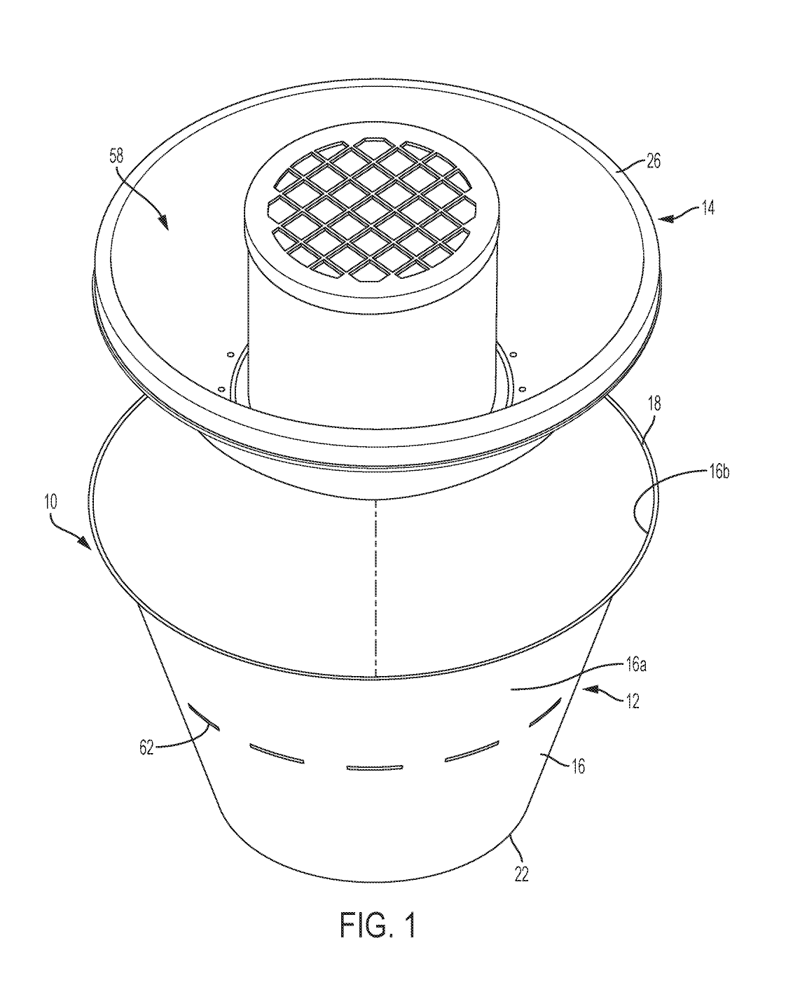

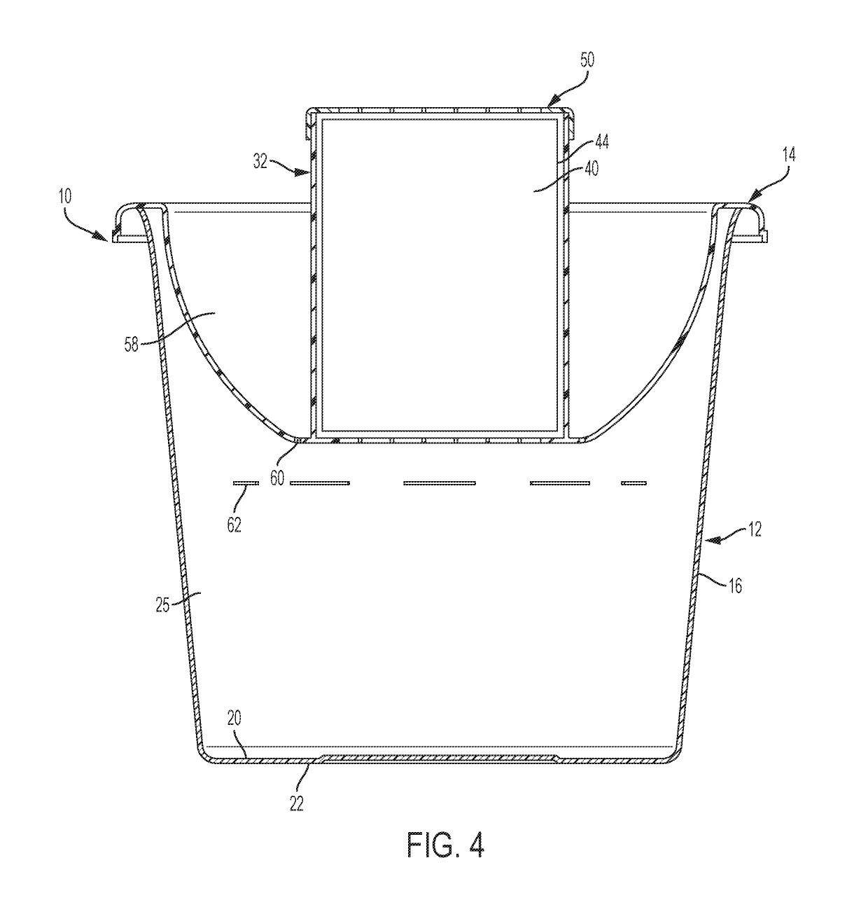

FIG. 1 shows an exploded view of an empty planter-trap 10 according to an embodiment of the invention. As shown, the planter-trap 10 is formed of at least a lower basin 12 and an upper insert 14. In this embodiment, basin 12 is formed of a rounded wall having an exterior surface 16a an interior surface 16b, and an upper lip 18. At their lower ends, basin walls 16 terminate in a floor surface 20 (best shown in FIG. 4). It will be understood that basin 12 may be formed in any of various shapes, including conical, cylindrical or square in different embodiments of the invention.

In embodiments of the invention, the lower segment of basin 12 forms a well that is configured to retain a predetermined volume of liquid such as water. As described, any of various quantities of decaying biological matter (e.g. hay) may be added to the water, thereby forming an infusion chamber 25 configured to attract mosquitoes.

In embodiments of the invention, upper insert 14 is releasably secured to basin 12 during use. For example, in embodiments of the invention, upper insert 14 includes a circular ring 26 having a track, channel or a series of retaining barbs configured to receive and grip upper lip 18 of basin 12. As such, upper insert 14 may be seated on basin 12 and selectively secured thereto. It will be understood that any of various temporary securement mechanisms may be used to temporarily secure upper insert 14 to basin 12 in different embodiments of the invention.

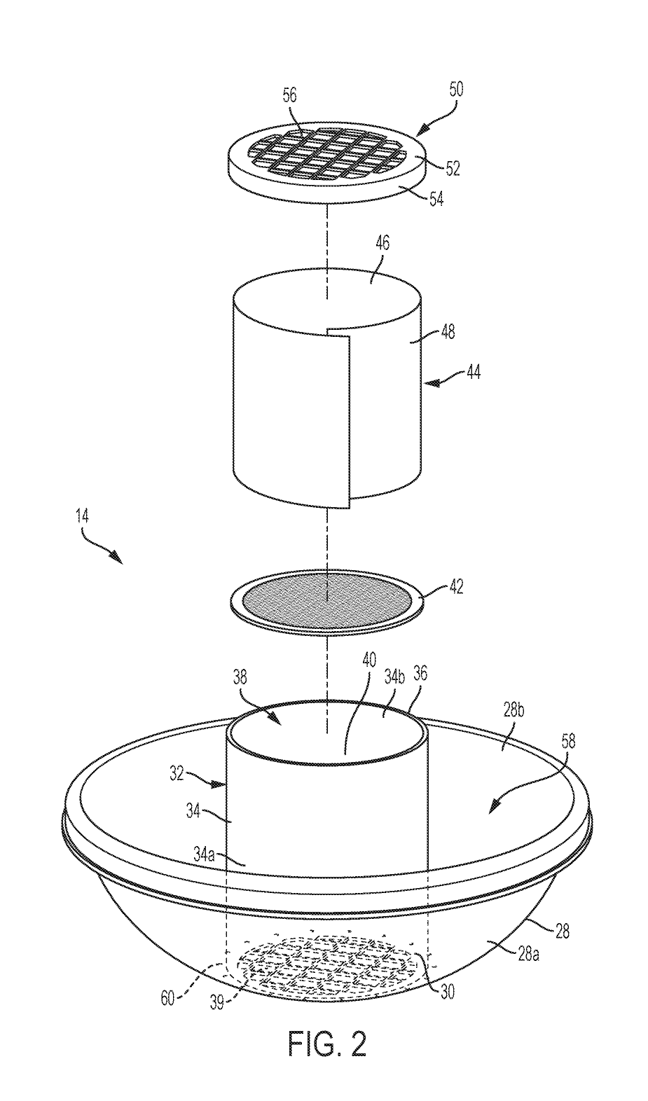

FIG. 2 shows an exploded view of upper insert 14 according to an embodiment of the invention. As shown, upper insert 14 is substantially bowl-shaped such that its walls 28 have an exterior surface 28a and interior surface 28b, which converge to form a lower floor surface 30. A vertical internal cylindrical member 32 is positioned in the center of insert 14. For example, in embodiments of the invention a cylinder 32, formed integrally with upper insert 14 extends upwardly from floor surface 30. Walls 34 of cylinder 32 have an exterior surface 34a, an interior surface 34b and an upper lip 36. Upper lip 36 defines an upper opening 38. It will be understood that cylinder may be formed as a separate unit that is attachable to floor surface 30 of upper insert 14. As described, the interior area of cylinder 32 defines a capture chamber 40 through which mosquitoes enter the planter-trap 10.

As shown, in embodiments of the invention, floor surface 30 of upper insert 14 is formed with a series of openings 39 which serves as a conduit between the infusion chamber 25 and the capture chamber 40.

In use, a removable screen 42 is placed within cylinder 32 and is positioned on the floor 30 of upper insert 14. Screen 42 is sized and shaped to cover openings 39 in floor 30, while at the same time allow mosquitoes to view and sense the standing water in the infusion chamber 25 below. In embodiments of the invention, pore sizes of screen 42 are larger than mosquito eggs, but smaller than mosquitoes. Screen 42, thus, is a selective barrier allowing for the passage of mosquito eggs, while blocking the passage of mosquitoes. As a result, a mosquito egg that is laid in the capture chamber 40 may pass through screen 42 and drop into the infusion chamber 25. However, should a mosquito develop from the egg, it will be blocked by the screen 42 from entering into the capture chamber 40 and it will instead remain trapped in the infusion chamber 25 until it dies.

As shown, in embodiments of the invention an adhesive sheet 44 is inserted into the capture chamber 40. Adhesive sheet preferably has an inner surface 46 that is coated with adhesive material (e.g. glue) and an outer surface 48 that is not coated with adhesive material. The adhesive sheet is rolled and inserted into cylinder 32 such that non-coated outer surface 48 contacts inner surface 34b of cylinder 32 and inner adhesive-coated surface 46 faces inward, toward the center of capture chamber 40.

In embodiments of the invention, a removable vented lid 50 is provided to cover capture chamber 40. For example, still referring to FIG. 2, the vented lid 50 has a circular top plate 52 and a collar 54 descending downwardly from and substantially orthogonally to top plate 52. Top plate 52 has a grill 56 (or a similar series of openings) to allow the ingress of mosquitoes into the capture chamber 40. When assembled, the vented lid 50 is seated on lip 36 of cylinder 32 such that collar 54 surrounds and contacts the outer surfaces 34a of cylinder 32.

FIG. 2 shows a trough 58 or similar trench that is configured to hold soil. In the exemplary embodiment shown, trough 58 is formed of at least two walls. First trough wall is the outer surface 34a of capture chamber walls 34, and the second trough wall is the interior surface 28b of bowl-shaped walls 28. It will be understood by those of ordinary skill in the art that a trough may be formed in any of various configurations whereby at least a first wall and second opposing wall are joined or bridged to each other by way of a floor or similar surface.

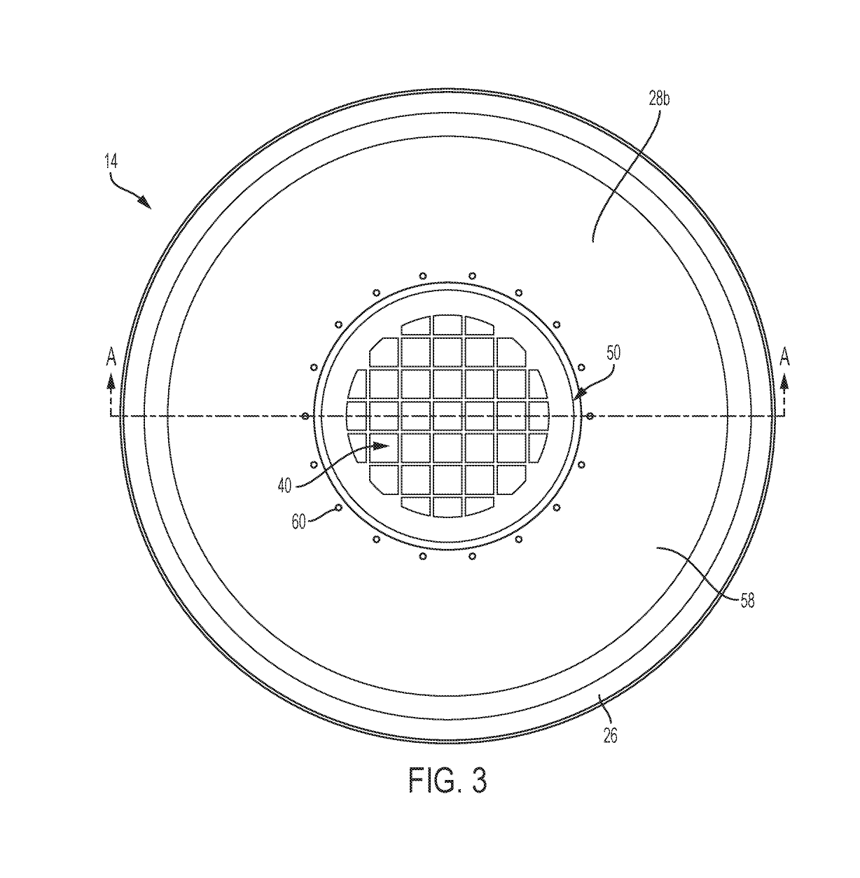

FIG. 3 shows a top view of upper insert 14 seated on basin 12. Trough 58 is shown surrounding capture chamber 40. In embodiments of the invention, one or more small drainage apertures 60 are made through walls 28 of upper insert 14. Drainage apertures 60 are preferably made at a lower segment of trough 58, for example, in an area proximate to floor surface 30. Drainage apertures 60 are configured to allow water to pass from the trough 58 into the infusion chamber 25. In this manner, water mixed with biological plant material adds biological matter to the infusion chamber when the plant is watered or receives rainfall.

It is understood by those of ordinary skill in the art that to the extent that mosquito eggs or larvae may be present in the infusion chamber 25, such eggs or larvae may be delivered into the capture chamber 40 if the water level in the basin 12 were allowed to rise into the capture chamber 40. Once in the capture chamber 40, mature mosquitoes spawned from the eggs or larvae would be able to escape through the holes 56 in cap 50. To prevent such occurrence, a drain system is provided to maintain the water in the infusion chamber at a level that is below the capture chamber 40. With reference to FIG. 4 which shows a cross-sectional view of a planter-trap taken through plane A-A of FIG. 3, in an embodiment of the invention, a series of slits 62 are made in the walls 16 of basin 12. Slits 62, are overfill drain holes that allow outflow of water from the basin 12, thereby preventing the water level in the basin 12 from rising above the level of the slits 62. The slits 62, as such, provide a safety mechanism by preventing the water level from rising into capture chamber 40. It will be understood by those of ordinary skill in the art that width of slits 62 are smaller than the size of a formed mosquito. Thus, in embodiments of the invention, the well segment of basin 12 is configured to retain a predetermined maximum volume of water. That is, the capacity of the infusion chamber 25 is the basin volume between the slits 62 and the floor surface 20.

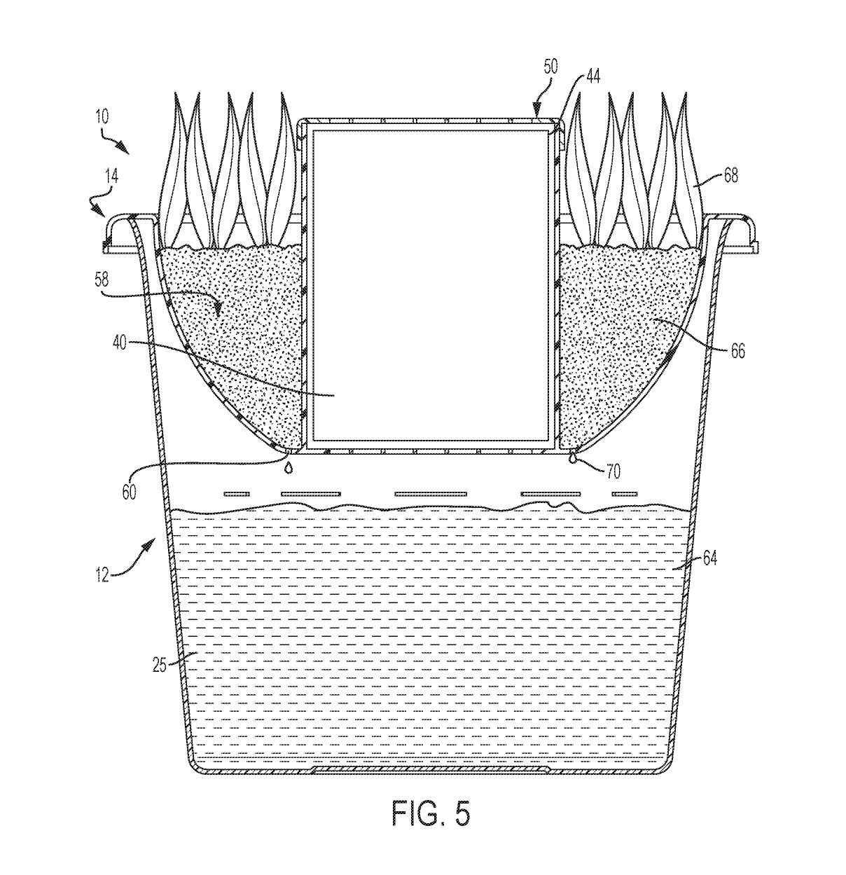

FIG. 5 shows a cross-sectional view of a planter-trap in use according to an embodiments of the invention. As shown, infusion chamber 25 is filled with water 64 and hay or similar decaying matter (not shown). In addition, trough 58 is filled with soil 66, which supports live plant 68. When plant 68 is watered or is rained on, water flowing through the soil system drains out of holes 60 and falls into the infusion chamber 25 below the upper insert 14. For example, in FIG. 5, a droplet of water 70 is shown falling from hole 60. Significantly, water 70 dripping from soil 66 may contain plant and soil matter and/or other biological components—thereby enhancing the attractiveness of infusion chamber 25 to mosquitoes.

Plant 68 and its associated foliage also assist in attracting mosquitoes. In this regard, adult mosquitoes are known to like resting on vegetation. Thus, the plant 68 and its leaves or other foliage serve as an additional attractant to adult mosquitoes.

In embodiments of the invention, trough 58 is substantially circular in shape forming a ring that circumscribes capture chamber 40. It will be understood by those of ordinary skill in the art, however, that other types of arrangement are possible in different embodiments of the invention. For example, in embodiments of the invention capture chamber and a plant/soil system may be disposed substantially in a side-by-side orientation. Alternatively, a plant may be disposed in the center of the unit, and a capture chamber may be formed of a ring that surrounds the plant/soil system.

In embodiments of the invention, and as best shown in the cross-sectional view of FIGS. 4 and 5, the entrance (e.g. vented lid 50) to the capture chamber 40 extends above the level of trough 58. In embodiments of the invention, the entrance to capture chamber 40 is of sufficient height above the trough to prevent the entrance from being covered or obscured by plant foliage.

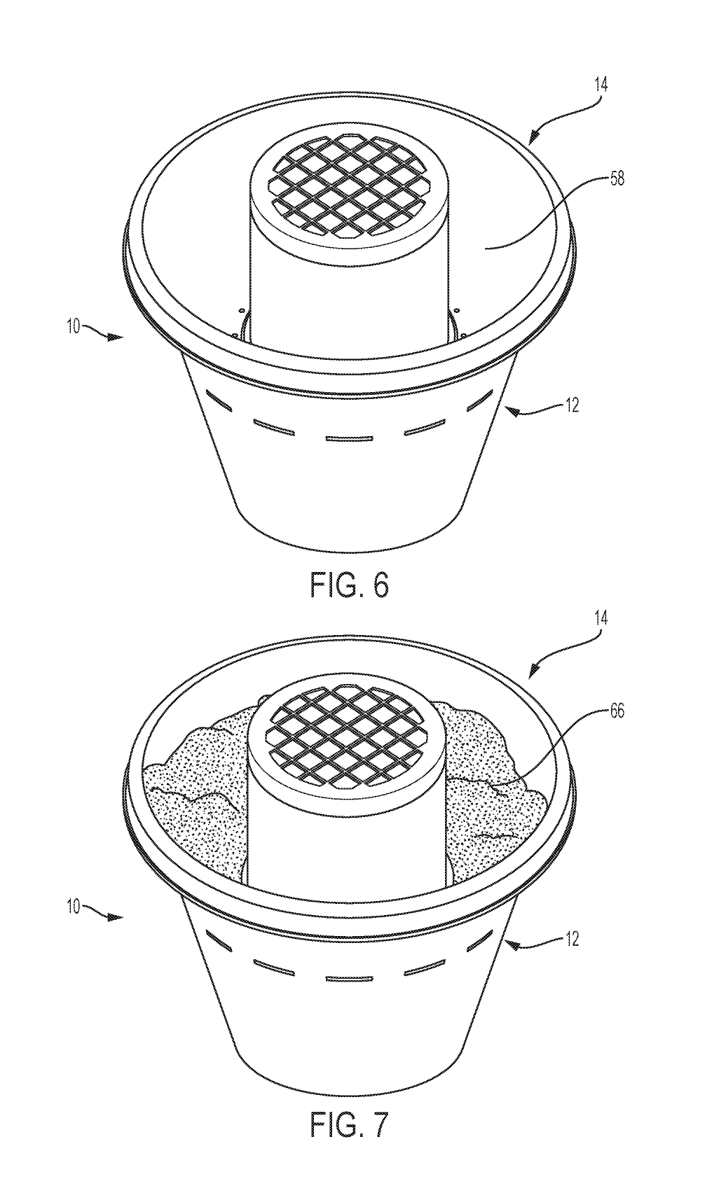

FIG. 6 shows a top perspective view of a planter-trap shown empty according to an embodiment of the invention. In an exemplary set up of the planter-trap, a user initially removes the upper insert 14 and fills basin 16 with water. Optionally, the user may add hay other plant matter into the infusion chamber 25. Thereafter, the insert 14 is placed atop of basin 12 and any securement mechanism is engaged to temporarily secure insert 14 to basin 12. Next, with reference to FIG. 7, trough 58 is filled with soil 66 and is seeded with desired plant seeds. Alternatively, a pre-grown circular plant and soil system is inserted into the trough 58. The user may place one or more planter-traps at various locations for decorative purposes. After deployment of the planter-traps, a user may periodically water the plant with a sufficient amount of water to saturate the soil 66 such that excess water drains from trough 58 into the infusion chamber 25 positioned below it.

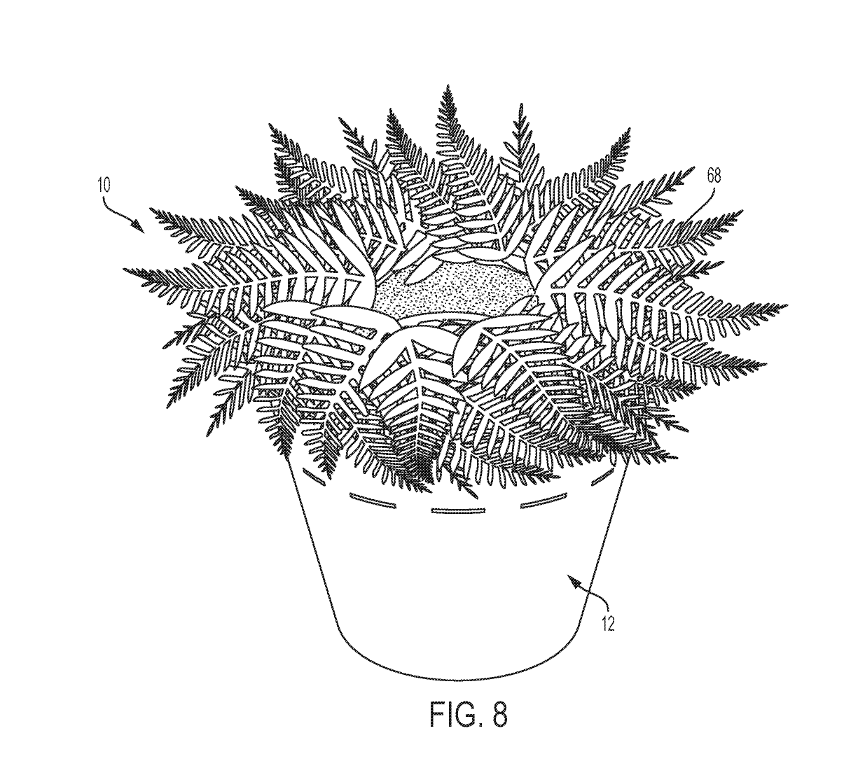

FIG. 8 is a top perspective view of a planter-trap according to an embodiment of shown supporting a plant 68. As shown, the planter-trap 10 looks like a conventional planter and is suitable for outdoor decoration. The plant 68 also surrounds the center trap segment and thereby helps to obscure it from view.

The planter-trap system of the invention provides a method of attracting mosquitoes by providing a combination of foliage and continued infusions of biological material. The system also provides a method of automatically replenishing biological attractants by integrating a plant system with a trapping system.

The planter-trap system of the invention, allows for a method of increasing effectiveness, increasing adoptability and decreasing maintenance requirements of ovitraps. That is, as stated, a level of biological material in the infusion chamber 25 is self-sustained by water or rainfall washing through the soil 66 and sweeping biological materials into the infusion chamber 25. Moreover, the presence of vegetation provides increased attractability of the system.

Having described the subject matter of the application with regard to specific embodiments, it is to be understood that the description is not meant as a limitation since further modifications and variations may be apparent or may suggest themselves to those skilled in the art. It is intended that the present application cover all such modifications and variations.

What is claimed is:

1) A mosquito trap, comprising:
a basin having walls, a floor surface and an upper lip;
an infusion chamber comprising an area within the basin that is configured to hold a predetermined volume of liquid;
a capture chamber suspended above the infusion chamber, the capture chamber comprising walls and a floor surface having a plurality of holes;
a trough configured to receive soil suspended above the infusion chamber, the trough comprising a plurality of drainage holes configured to deliver water from the trough to the infusion chamber.

2) The mosquito trap of claim 1, whereby the trough and the capture chamber comprise an insert configured to be seated on the basin.

3) The mosquito trap of claim 2, whereby the walls of capture chamber substantially form a cylinder having a first open end and a second end terminating in the floor surface of the capture chamber.

4) The mosquito trap of claim 2, whereby the trough surrounds the capture chamber.

5) The mosquito trap of claim 4, whereby the trough is substantially circular in shape.

6) The mosquito trap of claim 1, whereby the capture chamber walls comprise an inner surface and an outer surface.

7) The mosquito trip of claim 6, whereby the trough comprises a first wall and a second wall, the first wall of the trough comprising the outer surface of the capture chamber.

8) The mosquito trap of claim 1, further comprising a screen adapted to cover the plurality of holes in the floor surface of the capture chamber.

9) The mosquito trap of claim 1, further comprising a removeable lid configured to cover the capture chamber.

10) The mosquito trap of claim 1, further comprising an adhesive sheet having a first side comprising an adhesive substance and a second side having no adhesive substance, the adhesive sheet configured to fit within the capture chamber.

11) A method of trapping mosquitoes, comprising the steps of:
providing a device comprising a basin, the basin further comprising a well segment configured to hold a predetermined volume of liquid;
adding liquid to the well segment;
suspending a capture chamber above the well segment;
suspending a trough above the well segment; and
adding soil to the trough for supporting vegetation.

12) The method of claim 1, further comprising the step of inserting a screen in the capture chamber, the screen comprising a selective barrier that allows eggs to pass from the capture chamber to the well segment, but blocks live mosquitoes from passing from the infusion chamber to the capture chamber.

13) The method of claim 1, further comprising the step of planting seeds in the soil.

14) The method of claim 1, further comprising the step of adding decaying biological matter to the liquid added to the well segment.

15) A method of adding bait to a mosquito trap, comprising the steps of:
providing a device comprising a basin, the basin further comprising a well segment configured to hold a predetermined volume of liquid;
adding liquid to the well segment;
suspending a capture chamber above the well segment;
suspending a trough having drainage holes above the well segment;
adding soil to the trough for supporting vegetation;
adding sufficient quantities of water to the soil such that excess water flows into the well segment by way of at least one of the drainage holes.
